(19) United States
(12) Patent Application Publication
(10) Pub. No.: US 2010/0225184 A1
(43) Pub. Date: Sep. 9, 2010

(54) SERVO MOTOR WITH IMPROVED HEAT DISSIPATION EFFICIENCY

(75) Inventors: SHAO-CHUNG YUAN, Tu-Cheng (TW); YIN-JAO LUO, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/468,823

(22) Filed: May 19, 2009

(30) Foreign Application Priority Data
Mar. 5, 2009 (CN) 200910300695.4

(51) Int. Cl. H02K 9/06

(52) U.S. Cl. 310/62

(57) ABSTRACT

A servo motor includes an enclosure defining airflow passages in the outer surface thereof, an end cover attached to the enclosure, a rotor shaft accommodated in the enclosure and having an end protruding out of the end cover, an encoder attached to the protruding end of the rotor shaft, an encoder cover attached to the end cover and covering the encoder, a fan duct covering the end cover, and a fan attached to the fan duct. The end cover, the encoder cover, and the fan duct cooperatively define an airflow space communicating with the airflow passages of the enclosure. The encoder cover includes a guiding portion gradually shrinking toward a small end which is away from the end cover. The fan duct includes a guiding portion gradually shrinking toward an end to which the fan is attached, thereby to guide the airflow smoothly flow toward the fan.

### BACKGROUND

1. Technical Field

The disclosure relates to servo motors and, particularly, to a servo motor which has improved heat dissipation efficiency.

2. Description of Related Art

Typically, a servo motor generates a great amount of heat during operation. The accumulation of heat will increase the temperature of the servo motor, possibly damaging insulation material of the servo motor, and shorten the lifespan of the servo motor.

One servo motor includes a cylindrical enclosure at one end. The cylindrical enclosure forms an end wall perpendicular to the axis thereof for mounting a fan thereon. However, part of the airflow vertically strikes against the end wall, thereby forming turbulent airflow in the enclosure. Thus, the airflow in the enclosure is not smoothly led out of the enclosure and the heat dissipation efficiency is lower than it could be.

### BRIEF DESCRIPTION OF THE DRAWINGS

FIG. 1 is an exploded, isometric view showing an exemplary embodiment of a servo motor.

FIG. 2 is an assembled view of FIG. 1.

FIG. 3 is a cross-sectional view of FIG. 2, taken along line III-III.

### DETAILED DESCRIPTION

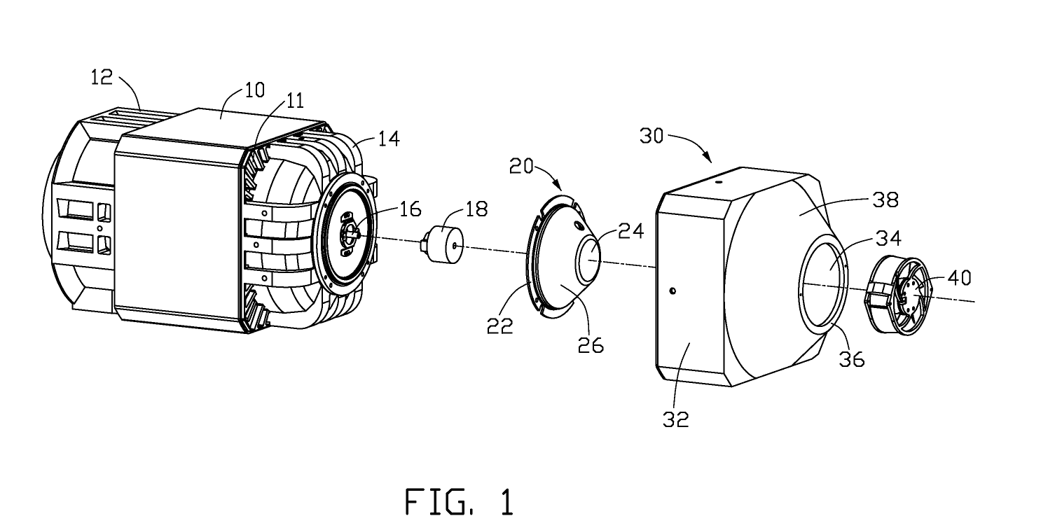

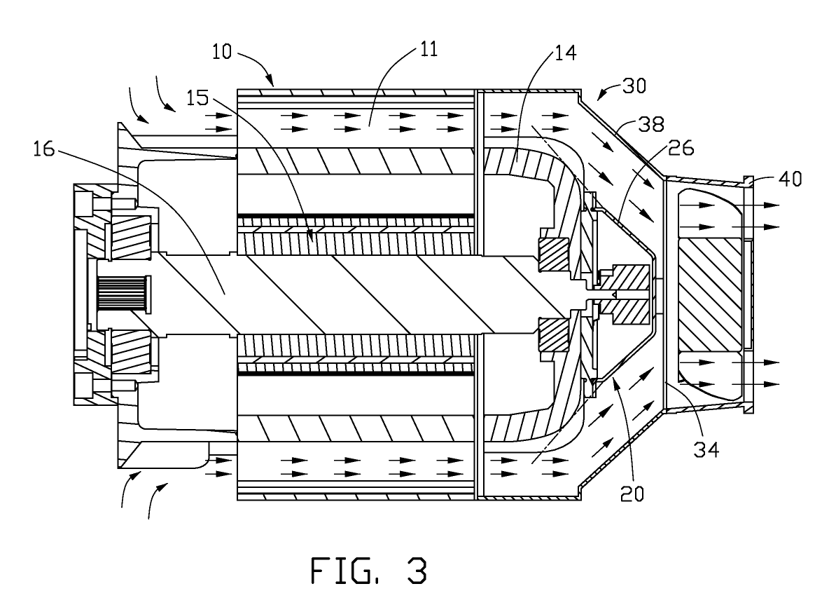

Referring to FIG. 1, an embodiment of a servo motor includes an enclosure 10, a front end cover 12, a rear end cover 14, a rotor 15 (see FIG. 3), an encoder 18, an encoder cover 20, a fan duct 30, and a fan 40. The enclosure 10 defines a plurality of airflow passages 11 embedded in the outer surface thereof. The rear end cover 14 includes a circumferential wall, a vertical end wall, and a transition arc between the circumferential wall and the vertical end wall. The rotor 15 is accommodated in the enclosure 10, and includes a rotor shaft 16, which has an end protruding out from an end wall of the rear end cover 14.

The encoder cover 20 includes a substantially cone-shaped hollow guiding portion 26. A flange 22 extends out from the large end of the encoder cover 20. An end wall 24 is formed at the small end of the encoder cover 20.

The fan duct 30 includes a substantially box-shaped frame 32 and a substantially cone-shaped hollow guiding portion 38. The large end of the guiding portion 38 connects to an end of the frame 32. The small end of the guiding portion 38 is bent to form a ring-shaped end portion 36, which defines a ventilation opening 34 therein.

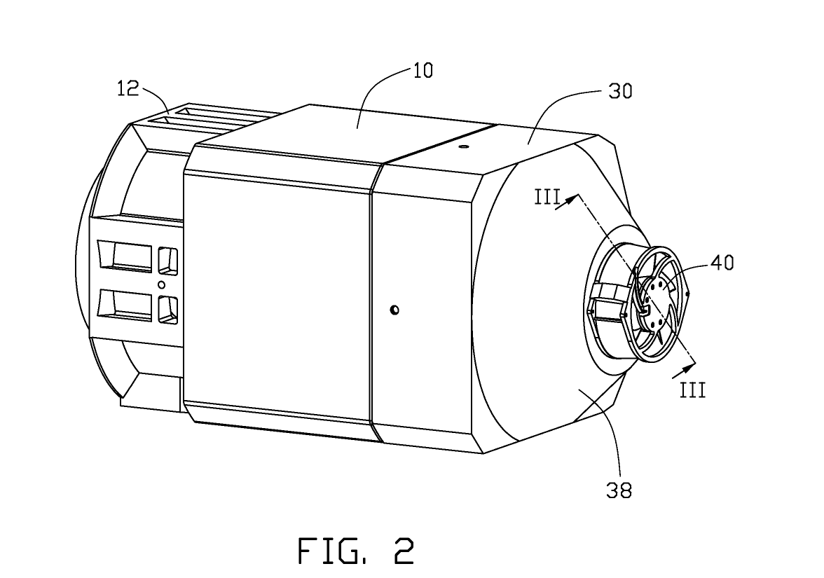

Referring to FIG. 2, in assembly, the encoder 18 is installed to the protruding end of the rotor shaft 16. The flange 22 of the encoder cover 20 is attached to the end wall of the rear end cover 14 to enclose the encoder 18 in the encoder cover 20 and protect the encoder 18 from impact and dust. The frame 32 of the fan duct 30 is mounted to the circumferential wall of the rear end cover 14 to enclose the rear end cover 14. The fan 40 is mounted to the ring-shaped end portion 36 of the fan duct 30. Thus, the rear end cover 14, the outer surface of the encoder cover 20, and the inner surface of the fan duct 30 cooperatively define an airflow space communicating with the airflow passages 11 of the enclosure 10.

Referring to FIG. 3, in this embodiment, the slant surface of the guiding portion 26 of the encoder cover 20 is located on the tangent of the transition arc of the rear end cover 14, for example, the tangent of the middle point of the transition arc. The cone-shaped guiding portions 26 and 38 are coaxial. The cross sections along the axis of the guiding portions 26 and 38 are two parallel isosceles trapezoids, that is, the slant surfaces of the guiding portions 26 and 38 are parallel. When the servo motor is in operation, the fan 40 expels the air from the fan duct 30. Air enters from the front end cover 12, flows through the airflow passages 11 of the enclosure 10, and then is smoothly guided by the rear end cover 14, the encoder cover 20, and the fan duct 30. Then, the air is expelled out from the opening 34 by the fan 40.

The airflow space defined by the rear end cover 14, the outer surface of the encoder cover 20, and the inner surface of the fan duct 30, can reduce the turbulence of the airflow, and make the airflow flow smoothly to increase the heat dissipation efficiency.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A servo motor comprising:
an enclosure defining a plurality of airflow passages embedded in the outer surface thereof,
an end cover attached to an end of the enclosure;
a rotor shaft accommodated in the enclosure and having an end protruding out of the end cover;
an encoder attached to the protruding end of the rotor shaft, and an encoder cover attached to the end cover and covering the encoder and the protruding end;
a fan duct attached to the enclosure and covering the end cover; and
a fan attached to the fan duct;
wherein the end cover, the encoder cover, and the fan duct cooperatively define an airflow space therebetween communicating with the airflow passages of the enclosure;
wherein the encoder cover comprises a guiding portion gradually shrinking from a large end which is connected to the end cover to a small end which is away from the end cover, the fan duct comprises a frame attached to the enclosure and a guiding portion gradually shrinking from the frame toward an end to which the fan is attached, thereby to guide the airflow smoothly flow toward the fan.

2. The servo motor of claim 1, wherein the end cover comprises a circumferential wall, an end wall, and a transition arc between the circumferential wall and the end wall

3. The servo motor of claim 2, wherein the guiding portion of the encoder cover is substantially hollow cone-shaped, a slant surface of the guiding portion of the encoder cover is located on the tangent of the transition arc of the end cover.

4. The servo motor of claim 3, wherein the slant surface of the guiding portion of the encoder cover is located on the tangent of the middle point of the transition arc.

5. The servo motor of claim 3, wherein the guiding portion of the fan duct is substantially hollow cone-shaped, the cross sections along the axis of the guiding portions of the fan duct and the encoder cover are two parallel isosceles trapezoids.

6. The servo motor of claim 1, wherein a flange extends out from the large end of the encoder cover, an end wall is formed at the small end of the encoder cover to shield the encoder therein.

7. The servo motor of claim 1, wherein the end of the guiding portion to which the fan is attached is bent to form a ring-shaped end portion which defines a ventilation opening therein, the air expelled by the fan flows through the ventilation opening.
